(19) United States
(12) Patent Application Publication
(10) Pub. No.: US 2008/0127794 A1
(43) Pub. Date: Jun. 5, 2008

(54) HoleClamp

(76) Inventor: Jerome Francis Jaksha, Rio Rancho, NM (US)

Correspondence Address: Jerome Jaksha, 804 Tulip Rd., Rio Rancho, NM, 87124, US

(21) Appl. No.: 11/937,482

(22) Filed: Nov. 8, 2007

Related U.S. Application Data
(60) Provisional application No. 60/858,271, filed on Nov. 8, 2006.

(51) Int. Cl. B26D 7/06; B26D 7/02

(52) U.S. Cl. 83/409; 83/468.2

(57) ABSTRACT

A sub fence clamping system incorporating c-clamps (9) which have a cylindrical legs (1) placed into vertical holes in a sub fence (11), rather than over and onto the work guiding face of the sub fence. Now vertical boards can be milled safely using this system. Pressure to clamp the sub fence to main guide fence is created by a threaded screw (4), cam (8) or other device. The end of the cylindrical leg can be made to protrude (7) toward the opposing leg, insuring pressure at that point only. Replacement sacrificial sub fences (10) are easily drilled to receive the cylindrical end of the clamp. These sacrificial sub fences are used on tablesaws (12) for rabbeting, and shapers for making cuts needing the zero clearance opening of a safer sacrificial fence. With no clamp on the face of the sub fence, steel plates for a magnetic feather board can be attached to a wood sub fence (13).

This invention is a new type of clamp which can be used to temporarily attach a guide fence, zero clearance fence, or other device to the guide fence used to support material on a stationary tool. Sacrificial wood sub-fences are used in many situations for safety and to add capability to the machine. Clamping a sub-fence to the guide fence of a stationary power tool such as a table saw traditionally has been done using c-clamps which clamp over the sub-fence. Traditional c-clamps are in the way of push sticks and wood moving along the table saw fence past the blade because of these over-hanging clamp ends.

The holeclamp is a fast, inexpensive tool for solving the problem of how to attach these sub-fences.

The holeclamp eliminates this protrusion, allowing thick boards and boards on edge to be run smoothly past the sub-fence. To attach the sub-fence, two holes are drilled vertically into a sub-fence, two holeclamps inserted, and the sub-fence clamped to the main fence with no c-clamp heads protruding over the face of the board fastened. With the holes drilled to be an easy press fit, the clamps stay with the sub-fence with no connectors. This makes attaching and removing the sub-fence easier.

1. One reason this is done is to attach a sacrificial fence which is cut into by the cutting blade. This is used in rabbiting operations.

2. Another reason is to extend the length of the fence temporarily, so that the edges of a sheet of plywood are supported until the board is past a saw blade.

3. Another is to attach a thin board in front of a blade, and a thicker board after the blade on both router table and table saw, so that a jointing operation can be done on those tools.

4. Another reason to attach a wood fence is to attach a higher fence to support a vertical board being cut.

5. Another reason to attach a wood fence is to allow a woodworker to attach accessories such as metal plates, guards, and pushing devices temporarily to a fence.

6. Another reason to attach a wood fence is to create a zero clearance fence for routing and crosscutting on table saws and chop saws.

7. Possibly the best reason to add a wood fence is to allow the use of magnetic featherboards on a steel plate attached to the wood sub-fence.

The cylindrical pillar can be made with a larger radius at the end of the pillar. This places the clamping pressure in the center of the sub-fence by counteracting the bending inherent in any c-clamp.

Manufactured or user built specialized clamping heads can be easily slipped on to the cylinder pillar. These can be held on by press fit, threading the end of the pillar, or adhering magnets into the hole in the clamping head.

The “hole clamp” is a specialized c-clamp which clamps into, rather than over sub-fences and other clamp accessories. The “hole clamp” is similar in structure to a traditional simple C-clamp except for the non moving end which is cylindrical to allow placement into any hole the same size as the cylinder. It is also possible to produce a clamping action using a cam rotating on the end of the clamping arm, if the clamping arm is cylindrical.

Traditional C-clamps have a flat end on the pillar to spread the load and not indent the material clamped. The clamp of the this invention spreads the load through the material clamped by matching the curve of the cylinder with the curve of a hole drilled into the object clamped.

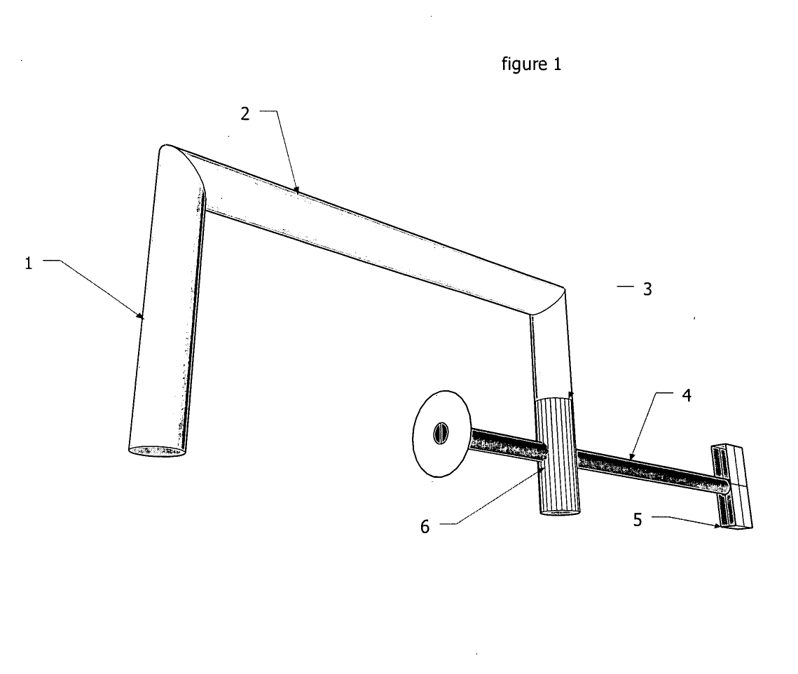

FIG. 1 Shows one embodiment of the invention of the holeclamp as seen from the front. The clamp depicted in FIG. 1 consists of pillar 1, a backbone 2, and a clamping arm 3, all made from a single steel rod. The threaded rod is turned in the female threads of hole 6 with thumbscrew 5 to create pressure between pillar 1 and clamping arm 3.

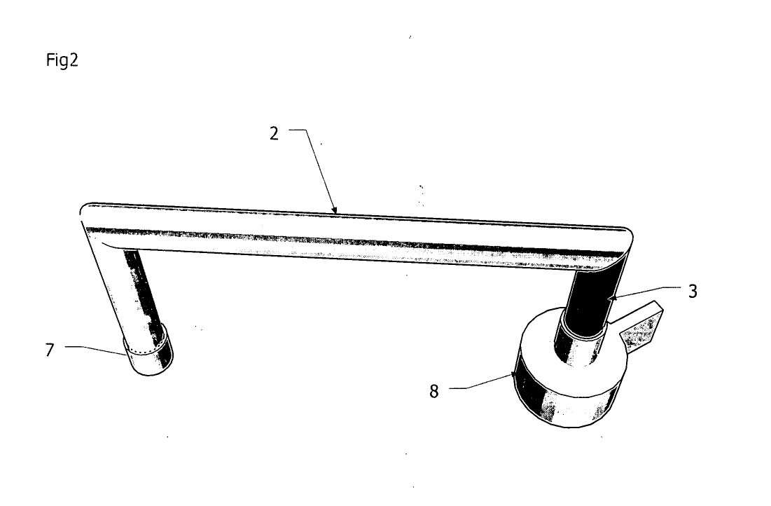

FIG. 2 Shows a top view of a modification of the working embodiment illustrated in FIG. 1 with a larger diameter tip 7 on the cylindrical pillar and a rotating cam 8 for applying pressure.

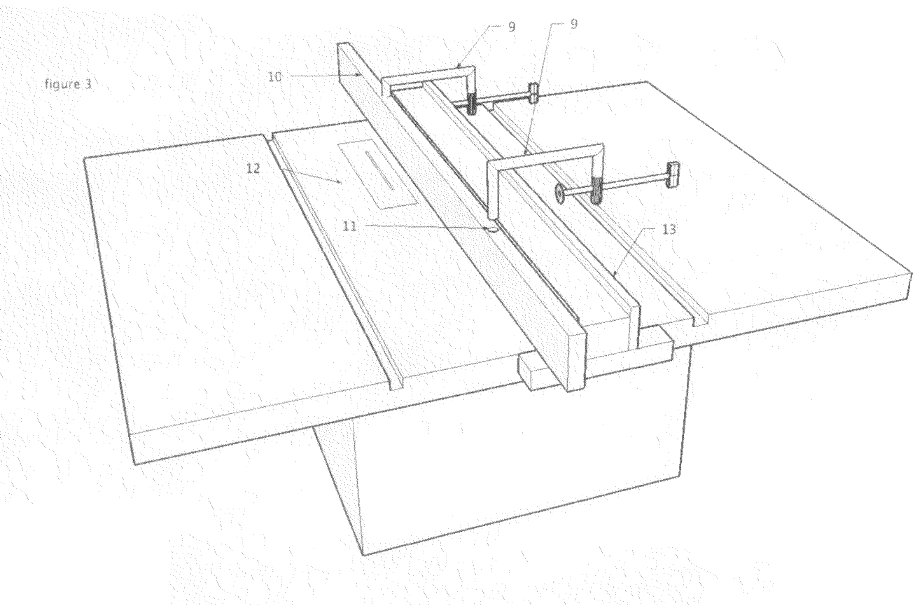

FIG. 3 Shows the sub-fence 10 and holeclamps 9 on a table saw 12 rip fence 13. One holeclamp is inserted in the hole of the sub-fence 10 and the other is above the vertical hole 11 in sub-fence 10

The clamp of FIG. 2 shows a ring 7 over the end of cylindrical pillar 1 .This enlarged area places the clamping pressure in the center of the sub-fence by counteracting the bending inherent in any c-clamp. The clamping arm 3 of FIG. 2 shows an eccentric cam which can be rotated around clamping arm 3 to provide pressure between pillar 1 and clamping arm 3

In FIG. 3 one clamp is in place, holding the sub-fence in position. The second clamp is in position to be moved into the vertical hole in the sub-fence.

I claim:

1. A sub-fence assembly comprising a sub-fence having one or more vertical round holes and clamps having a cylindrical pillar end inserted into said round vertical holes, a clamp backbone, a clamping arm parallel to said cylindrical pillar, and a clamping means for applying pressure between said pillar and said clamping arm.

2. A clamp comprising a cylindrical pillar wherein the cylindrical pillar is relatively larger in diameter at the tip than the neck of the pillar, an attached backbone, and a clamping arm attached parallel to said cylindrical pillar

3. A clamp comprising a cylindrical pillar, an attached backbone, a clamping arm attached parallel to said cylindrical pillar, and a clamping means for applying pressure between said pillar and said clamping arm.

2. The clamp as claimed in claim 3, wherein the clamping part further comprises a thumbscrew.

3. The screw clamp as claimed in claim 3, wherein the clamping part further comprises a cam rotating around a cylindrical backing arm.

5. The clamp as claimed in claim 3, wherein the cylindrical pillar is larger in diameter at the tip than the neck of the pillar.

6. The clamp as claimed in claim 2 wherein the clamp cylindrical pillar, backing arm, and clamping arm are formed from a continuous a round bar.
